(19) United States
(12) Patent Application Publication
(10) Pub. No.: US 2003/0174141 A1
(43) Pub. Date: Sep. 18, 2003

(54) Sorting image primitives in generation of image page descriptions

(76) Inventor: Nolan Wayne Letellier, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/097,993

(22) Filed: Mar. 14, 2002

(51) Int. Cl. G09G 5/00

(52) U.S. Cl. 345/582

(57) ABSTRACT

Image page contents are reordered based on image primitive types without altering the appearance of the rendered page. The reordering facilitates improving the locality of data or of the code executed in processing that data within the print stream. Where the imaging device is permitted to render like image primitives in sequence, the device's formatter is more likely to experience a cache hit for the desired code or data such that it's processor will experience less wait time by not having to access bulk memory as often.

### FIELD OF THE INVENTION

The present invention relates generally to sorting of image primitives in the generation of image page descriptions.

### BACKGROUND

Imaging devices are found in a vast number of computer networks and personal computer setups. Imaging devices include printers, plotters, multi-function devices and other devices used for applying an image to a tangible print media, such as paper, transparencies, card stock and more.

The image data is typically generated by some user application in a device external to the imaging device. An example includes composing an image in a graphics application of a computer workstation, generating image data in the graphics application and communicating the image data to a networked or local printer to produce a hard copy of the document.

For communications efficiency, the image data is generally provided to the imaging device in a compressed form. The compressed form may be simply a compression of raster data, but is more commonly a high-level page description language (PDL) providing information to the imaging device on how to recreate the image. These PDLs are often device-independent languages, i.e., the same image data can be provided to devices of differing types and/or differing manufacturers to produce an end result that is substantially the same. Examples of PDLs include Printer Command Language or PCL (Hewlett-Packard Company, Palo Alto, Calif., USA), PostScript® (Adobe Systems Incorporated, San Jose, Calif., USA) and Interpress (Xerox Corporation, Stamford, Conn., USA).

To process these PDLs, imaging devices have what is often referred to as a formatter. The formatter has a processor that is responsive to a control program to convert the image data to a printable image. The control program typically provides interpretation of the PDLs, character generation, device emulation, etc. The printable image is typically uncompressed raster or bitmap information that is supplied to another component of the imaging device, often referred to as an engine. The engine controls the mechanical components of the imaging device to produce a tangible output, such as a hardcopy of the printable image. Rasterizing of the page description can often become a bottleneck in the process of generating a tangible output image such that the print engine is waiting on further input from the formatter.

For the reasons stated above, and for other reasons stated below that will become apparent to those skilled in the art upon reading and understanding the present specification, there is a need in the art for alternative methods and apparatus for increasing the throughput of the formatter of an imaging device.

### SUMMARY

The various embodiments reorder page contents without altering the appearance of the rendered page. The reordering facilitates improving the locality of data or of the code executed in processing that data within the print stream. Where the imaging device is permitted to render like image primitives in sequence, the device's formatter is more likely to experience a cache hit for the desired code or data such that its processor will experience less wait time by not having to access bulk memory as often.

For one embodiment, the invention provides a method of generating an image page description. The method includes generating a set of image primitives and ordering the set of image primitives based on image primitive type.

For another embodiment, the invention provides a method of generating an image page description. The method includes translating image data into data representative of a plurality of image primitives having at least two types and sorting the data representative of the plurality of image primitives such that data representative of an image primitive of each type is grouped with data representative of the other image primitives of that type.

For yet another embodiment, the invention provides a method of generating an image page description. The method includes identifying a set of image primitives of an image page and identifying one or more mutually-exclusive first subsets of the image primitives. Each first subset contains like image primitives and image primitives of each first subset are independent of image primitives of other first subsets. The method further includes identifying one or more mutually-exclusive second subsets of the image primitives. Each second subset contains like image primitives and image primitives of each second subset are dependent upon image primitives of one or more other subsets. The method still further includes ordering the set of image primitives to include a sequence of the first and second subsets of the image primitives where a location of each second subset in the sequence is limited by a location of each subset on which it depends. The method still further includes generating the image page description using the sequence of the first and second subsets.

For a further embodiment, the invention provides a computer-usable media having computer-readable instructions stored thereon capable of causing a processor to perform a method. The method includes arranging contents of an image page description, wherein the arranging is based, at least in part, on grouping data representative of image primitives by image primitive type.

For a still further embodiment, the invention provides a system for generating an image page description. The system includes means for identifying mutually-independent subsets of image primitives for use by an imaging device to generate a tangible output image, wherein each mutually-independent subset contains one or more image primitives of a single type. The system further includes means for ordering the mutually-independent subsets of image primitives into a sequence of subsets and means for generating the image page description from the ordered sequence of subsets.

Further embodiments of the invention include methods and apparatus of varying scope.

### DESCRIPTION OF THE DRAWINGS

FIG. 1 is a schematic of one system for use in generating a tangible output image in accordance with an embodiment of the invention.

FIG. 2 is a flow chart of a method of generating an image page description in accordance with one embodiment of the invention.

FIG. 3 is a flow chart of a method of generating an image page description in accordance with another embodiment of the invention.

FIG. 4 is a conceptualization of a set of image primitives of an image page used for generating an output image.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Computers and other processor-based systems are used to generate a variety of output for viewing by a user or other person. Oftentimes, this output is generated in a tangible form such as on paper or other print media. Imaging devices are utilized to generate this tangible output image. Examples of imaging devices include inkjet printers, laser printers, multi-function devices and other devices adapted to print text, graphics and other images onto print media. The imaging devices produce the tangible output image in response to an image page description. The image page description contains information necessary for the imaging device to reproduce the desired image on the print media.

Because of the diversity of processor-based systems, user applications and imaging devices, device drivers are used to translate the image data from the user application into the language of an image page description. These page description languages (PDLs) are often device-independent languages, i.e., the same image data can be provided to devices of differing types and/or differing manufacturers to produce an end result that is substantially the same. Examples of PDLs include Printer Command Language or PCL (Hewlett-Packard Company, Palo Alto, Calif., USA), PostScript® (Adobe Systems Incorporated, San Jose, Calif., USA) and Interpress (Xerox Corporation, Stamford, Conn., USA).

To process these PDLs, imaging devices have what is often referred to as a formatter. The formatter has a processor that is responsive to a control program to convert the image data to a printable image. The control program typically provides interpretation of the PDLs, character generation, device emulation, etc. The printable image is typically uncompressed raster or bitmap information that is supplied to another component of the imaging device, often referred to as an engine. The engine controls the mechanical components of the imaging device to produce a tangible output, such as a hardcopy of the printable image.

Formatters generally include cache memory. Cache memory is well understood in the art and will not be described in detail herein. In general, cache memory is a small amount of memory having a faster access time than is available from bulk memory devices across a system bus. Primary or level 1 (L1) cache is generally built into the processor itself. Because of the cost constraints of L1 cache, most systems further utilize a secondary or level 2 (L2) cache. The L2 cache typically resides on a memory card in close proximity to the processor having a direct connection to the process. A dedicated L2 controller regulates the use of the L2 cache by the processor. Although it is typical to have the L2 cache physically separate from the processor, some systems incorporate the L2 cache within the processor similar to the L1 cache.

The purpose of cache memory is to reduce the wait time experienced by a processor in accessing data or instructions from storage. Cache produces this reduction in wait time because much of the information utilized by a processor is used repeatedly. Information utilized by the processor is placed in cache. When the processor requests further information, it first looks to its cache memory to see if it is available. If it is, the processor retrieves the information from cache. This is termed a cache hit. If the information is not available in cache, the processor retrieves the information from some other computer-usable media. This is termed a cache miss. There are a variety of algorithms used to decide what information to store in cache to increase the likelihood of a cache hit. These algorithms are outside the scope of the invention, but generally look to the repetition of information requested by the processor in determining what information to store in cache. The various embodiments seek to increase the level of repetition in information requests by ordering the data provided to the processor. By grouping like image primitive types together within the image page description, information requested by the formatter's processor used to render those image primitives will likely exhibit an increased level of repetition. This, in turn, will increase the likelihood of a cache hit as the cache algorithms will be more likely to store the requested information in cache.

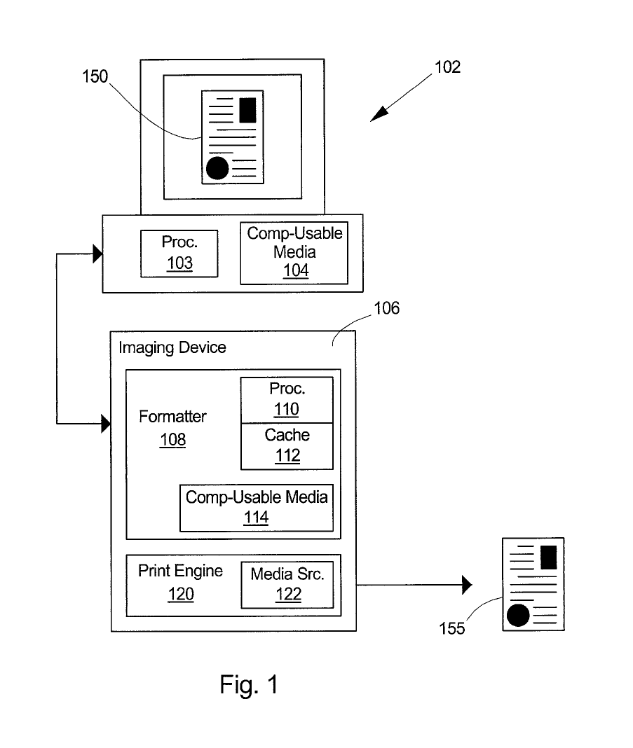

An image page description is processed by an imaging device to produce the tangible output image. FIG. 1 is a schematic of one system for use in generating a tangible output image in accordance with an embodiment of the invention. The system includes a personal computer, workstation or other processor-based device 102 used to generate and/or display an image 150. The image 150 can represent anything within the imagination of the user, whether it be text, a drawing, a photograph or some other image. The processor-based device 102 includes a processor 103 and a computer-usable media 104 in communication with the processor 103. The processor 103 generates an image page description of the image 150 for producing the desired output image 155. The image page description is provided to an imaging device 106.

The processor 103 is adapted to perform methods in accordance with embodiments of the invention in response to computer-readable instructions. These computer-readable instructions are stored on the computer-usable media 104 and may be in the form of either software, firmware or hardware. As a whole, these computer-readable instructions are often termed a device driver, translating the image data into a format usable by a device or class of devices. In a hardware solution, the instructions are hard coded as part of a processor, e.g., an application-specific integrated circuit (ASIC) chip. In a software or firmware solution, the instructions are stored for retrieval by the processor. Some additional examples of computer-usable media include static or dynamic random access memory (SRAM or DRAM), read-only memory (ROM), electrically-erasable programmable ROM (EEPROM), magnetic media and optical media, whether permanent or removable. Most consumer-oriented computer applications are software solutions provided to the user on some removable computer-usable media, such as a compact disc read-only memory (CD-ROM).

The imaging device 106 has a formatter 108 for interpreting the image page description and rendering the image data into a printable image. The formatter 108 includes a processor 110 and its cache memory 112. The formatter 108 further includes a computer-usable media 114. Similar to the processor 103 of the processor-based system 102, the processor 110 of the formatter 108 is adapted to interpret the image page description and render the image data in response to computer-readable instructions stored on the computer-usable media 114. In addition, the computer-usable media 114 may be used to store the image page description for access by the processor 110. Guidelines for the computer-usable media 114 are substantially the same as the computer-usable media 104. Computer-readable instructions for operation of a processor may be stored on a read-only type of media, but data representative of the image page description must generally be stored on a rewritable type of media. Accordingly, the computer-usable media 104 and the computer-usable media 114 may each represent one or more types of media.

The printable image is provided to a print engine 120 to produce a tangible output image 155 on a print media. The print engine 120 represents the mechanical aspects of the imaging device 106. The print engine 120 further includes a media source 122 for supplying the print engine 120 with the print media. Examples of the source 122 include media trays or by-pass feeders.

The various embodiments facilitate performance improvement in the generation of tangible output images through a sorting or ordering of image primitives making up an image to take advantage of cache memory in an imaging device. If the image formatter is rendering like objects together, the cache is more likely to have that code available and the formatter's processor will be able to render those objects more quickly than if it had to first pull that code from the main system memory. Similarly, if the data describing those objects, or image primitives, is banked together in the data stream or print stream being supplied to the imaging device, there is “memory locality” of the image primitives such that the data representing the image primitives is itself more likely to result in a cache hit.

When graphics applications send data to a device driver, such as a printer driver, the application can arrange the data in a variety of ways, e.g., arranged by depth on the page, arranged by areas, arranged in the order a user created the image page, etc. The various embodiments utilize a reordering of these page contents based on the type of image primitive to be provided to an imaging device.

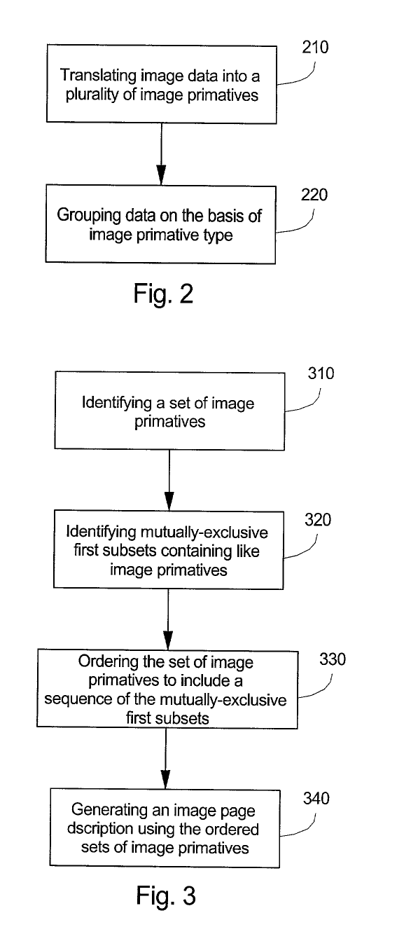

FIG. 2 is a flow chart of a method of generating an image page description in accordance with one embodiment of the invention. At block 210, image data is translated into a plurality of image primitives. The image primitives have at least two types. The image data is representative one or more image elements wherein each image element corresponds to one or more image primitives. An image primitive is an individual graphic entity. Examples include a vector, a line, a rectangle, a polygon, an individual character (by context or definition in a particular font, size), a raster image or a picture. Conceptually, an image primitive represents the output of a single graphical command to be interpreted by the imaging device formatter. An image element, a more complex graphic entity, is broken down into image primitives for use by the imaging device. For example, a single complex shape may be broken down into a number of contiguous polygons.

At block 220, the data representative of the plurality of image primitives is sorted such that data representative of an image primitive of each type is grouped with data representative of the other image primitives of that type, that is the sorting is based on image primitive type. Each type of image primitive is interpreted at the imaging device using a set of code specific to that imaging device. By processing similar primitives sequentially, that code is more likely to reside in the formatter's cache. Sorting of image primitives is possible because not every image primitive on a page relies on other image primitives. For example, interpretation of headers and footers, i.e., rendering the font, could be done at any time and they could be done together without regard for when other page contents are rendered. However, some image primitives are not independent and must be interpreted in the proper sequence. An example is a raster image on a page that forms the background for entire page. This raster image element might be a gradient background that can be broken into a series of rectangular image primitives of varying shade. These image primitives must be kept in the print stream such that they will still form the background for what is in the foreground. If such image primitives were placed in the print stream such that they are rendered after any foreground primitives, they could overwrite those foreground primitives.

Sorting of the data representative of the plurality of image primitives may include sorting the data such that data representative of an image primitive of each type is contiguous with data representative of the other image primitives of that type. This further improves the locality of the data. As data requested from a memory device is usually provided in blocks of predefined size, regardless of the amount of data actually requested, providing the data in a contiguous format improves the likelihood that at least a portion of the data for a subsequent image primitive will be in cache after processing the previous image primitive.

FIG. 3 is a flow chart of a method of generating an image page description in accordance with another embodiment of the invention. At block 310, a set of image primitives of an image page are identified. From this set, at least two mutually-exclusive first subsets are identified at block 320. Each of these subsets contains like image primitives that are independent of image primitives of other first subsets. At block 330, the set of image primitives is sorted to include a sequence of the first subsets of the image primitives. The image page description is then generated at block 340 using the ordered sets of image primitives. The image page description may then be sent as a print stream to an imaging device to produce the tangible image.

As discussed previously, not all image primitives are necessarily independent of other image primitives. As such, the method of FIG. 3 may further include identifying at least one additional mutually-exclusive subset of the image primitives that is not independent of image primitives of other subsets. Such additional subsets should be ordered within the set of image primitives to have a location that is dependent upon a location of one or more the subsets on which it depends. As an example, a subset of image primitives contained in a background might be ordered in the set of image primitives to have a location that is prior to a location of each subset contained in the foreground where image primitives are rendered in the order received. These foreground subsets may be limited to first subsets. Alternatively, one or more foreground subsets may be dependent upon other subsets, i.e., they may have other subsets in their foreground.

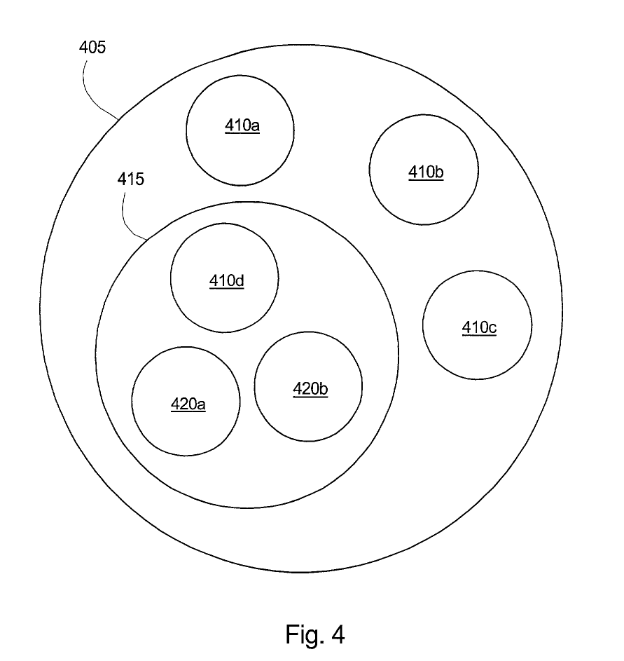

FIG. 4 is a conceptualization of the set of image primitives 405 of an image page used for generating an output image. The set of image primitives 405 includes two or more mutually-exclusive subsets 410 containing image primitives that are independent of other subsets 410. Subset 410a represents a subset of image primitives having a first type, e.g., vectors. Subset 410b represents a subset of image primitives having a second type, e.g., raster images. Subset 410c represents a subset of image primitives having a third type, e.g., text. Subset 415 represents a subset of image primitives having a fourth type, e.g., rectangles. Subset 415 contains a subset 410d that is independent of other subsets 410. Subset 415 further includes subsets 420a and 420b that are dependent upon one or more other subsets, i.e., the subsets 420 must be rendered prior to one or more of the other subsets.

For the following example, presume that the image primitives of subset 420a are in the background relative to all other image primitives and that the image primitives of subset 420b are in the background relative to only the image primitives of subset 410c. For this example, the image primitives of subset 420a are to be rendered prior to image primitives of all other subsets while the image primitives of subset 420b are to be rendered prior to at least those image primitives in subset 410c and after at least those image primitives in subset 420a. In this scenario, the image page description can thus be generated to contain a sequence of subsets in the order of 420a, 410d, 420b, 410c, 410a and 410b. It is noted that other sequences satisfy the criteria regarding dependency, i.e., providing for rendering of subset 420a to remain in the background of all other image primitives and rendering of subset 420b to remain in the background of the image primitives of subset 410c. Typically, this dependency is satisfied by providing background objects in the print stream prior to foreground objects. By grouping the image primitives into subsets by type and generating an image page description using a sequence of those subsets, the likelihood of a cache hit for the code required to render a specific type of image primitive, or the data representative of the primitive itself, can be improved.

### CONCLUSION

The various embodiments reorder page contents without altering the appearance of the rendered page. The reordering facilitates improving the locality of data or of the code executed in processing that data within the print stream. Where the imaging device is permitted to render like image primitives in sequence, the device's formatter is more likely to experience a cache hit for the desired code or data such that its processor will experience less wait time by not having to access bulk memory as often.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A method of generating an image page description, comprising:
generating a set of image primitives; and
ordering the set of image primitives based on image primitive type.

2. The method of claim 1, further comprising:
identifying image primitives of a first type that are independent of other image primitives; and
ordering the set of image primitives such that all of the identified independent image primitives of the first type are grouped together.

3. The method of claim 2, further comprising:
identifying image primitives of a second type that are dependent on other image primitives; and
ordering the set of image primitives such that all of the identified dependent image primitives of the second type are grouped together and are ordered to appear in a print stream prior to any image primitive on which they depend.

4. The method of claim 3, wherein the image primitives of the second type are the same type as the image primitives of the first type.

5. The method of claim 1, further comprising:
identifying image primitives that are independent of other image primitives; and
ordering the set of image primitives such that all of the identified independent image primitives of a given type are grouped with other identified independent image primitives of that type.

6. A method of generating an image page description, comprising:
translating image data into data representative of a plurality of image primitives having at least two types; and
sorting the data representative of the plurality of image primitives such that data representative of an image primitive of each type is grouped with data representative of the other image primitives of that type.

7. The method of claim 6, further comprising:
sorting the data representative of the plurality of image primitives such that data representative of an image primitive of each type is contiguous with data representative of the other image primitives of that type.

8. The method of claim 6, wherein the image data comprises data representative of one or more image elements and each image element corresponds to one or more image primitives.

9. The method of claim 6, further comprising:
identifying image primitives of a first type that are independent of other image primitives; and
sorting the data representative of the plurality of image primitives such that data representative of each image primitive of each type is grouped with data representative of the other image primitives of that type.

10. The method of claim 6, further comprising:
sorting the data representative of the plurality of image primitives of a first type into a plurality of subsets, wherein a first subset is dependent upon a second subset and wherein the first subset appears at a location in the sorted data relative to a location of the second subset such that an imaging device interpreting the image page description can render the image primitives of the first subset to be in the background of the image primitives of the second subset.

11. A method of generating an image page description, comprising:
identifying a set of image primitives of an image page;
identifying at least two mutually-exclusive subsets of the image primitives, wherein each subset contains like image primitives and wherein image primitives of each subset are independent of image primitives of other subsets;
ordering the set of image primitives to include a sequence of the subsets of the image primitives; and
generating the image page description using the ordered set of image primitives.

12. The method of claim 11, wherein ordering the set of image primitives further comprises ordering the set of image primitives to include a contiguous sequence containing all independent subsets of the image primitives.

13. The method of claim 11, further comprising:
identifying at least one additional mutually-exclusive subset of the image primitives that is not independent of image primitives of other subsets.

14. The method of claim 13, wherein a location of each additional subset in the ordered set of image primitives is dependent upon a location of one or more the subsets on which it depends.

15. The method of claim 14, wherein a location of an additional subset in the ordered set of image primitives is at a location relative to a location of any subset on which it depends such that an imaging device interpreting the image page description can render the image primitives of the additional subset to be in the background of the image primitives of each subset on which it depends.

16. The method of claim 14, wherein a location of an additional subset in the ordered set of image primitives is prior to a location of each subset on which it depends.

17. A method of generating an image page description, comprising:
identifying a set of image primitives of an image page;
identifying one or more mutually-exclusive first subsets of the image primitives, wherein each first subset contains like image primitives and wherein image primitives of each first subset are independent of image primitives of other first subsets;
identifying one or more mutually-exclusive second subsets of the image primitives, wherein each second subset contains like image primitives and wherein image primitives of each second subset are dependent upon image primitives of one or more other subsets;
ordering the set of image primitives to include a sequence of the first and second subsets of the image primitives, wherein a location of each second subset in the sequence is limited by a location of each subset on which it depends; and
generating the image page description using the sequence of the first and second subsets.

18. The method of claim 17, wherein each second subset is located in the sequence such that image primitives of each second subset will appear in a tangible output image of the image page description as background relative to image primitives of each subset on which it depends.

19. The method of claim 17, wherein each second subset is located in the sequence such that it will be rendered by an imaging device prior to rendering each subset on which it depends.

20. The method of claim 17, wherein the location of each second subset in the sequence is prior to a location of each subset on which it depends.

21. A computer-usable media having computer-readable instructions stored thereon capable of causing a processor to perform a method, the method comprising:
arranging contents of an image page description, wherein the arranging is based, at least in part, on grouping data representative of image primitives by image primitive type.

22. The computer-usable media of claim 21, wherein the method further comprises:
arranging the contents of the image page description into a sequence of subsets of image primitives, wherein each subset of image primitives contains one or more image primitives of a single type and wherein all image primitives of a single type that are independent of other image primitives are contained in a single subset.

23. A method of generating an image page description, comprising:
receiving an incoming data stream of image data, wherein the image data comprises data representative of one or more image elements;
translating the incoming data stream into a plurality of image primitives having at least two types, with each image element comprises one or more image primitives; and
grouping data representative of the image primitives such that data representative of an image primitive of a first type of a first image element is grouped with data representative of other image primitives of the first type for one or more other image elements.

24. The method of claim 23, wherein data representative of each image primitive of a given type that is independent of other image primitives of the given type is grouped together.

25. A system for generating an image page description, comprising:
means for identifying mutually-independent subsets of image primitives for use by an imaging device to generate a tangible output image, wherein each mutually-independent subset contains one or more image primitives of a single type;
means for ordering the mutually-independent subsets of image primitives into a sequence of subsets; and
means for generating the image page description from the ordered sequence of subsets.

26. The system of claim 25, wherein the means for identifying mutually-independent subsets further comprises:
means for identifying mutually-independent first subsets of image primitives containing image primitives that are independent of image primitives of other first subsets; and
means for identifying mutually-independent second subsets of image primitives containing image primitives that are dependent on image primitives of one or more other subsets.

27. The system of claim 25, wherein the means for ordering the mutually-independent subsets of image primitives into a sequence of subsets further comprises:
means for placing each second subset at a location in the sequence such that the imaging device would render image primitives of that second subset to be in the background of image primitives of each subset on which it depends.
